(19) United States
(12) Patent Application Publication
(10) Pub. No.: US 2026/0295471 A1
(43) Pub. Date: Oct. 1, 2026

(54) MAGNETICALLY-DRIVEN PHASE SEPARATOR

(71) Applicant: Honeywell International Inc., Charlotte, NC (US)

(72) Inventors: Mehrad Mehr, Morristown, NJ (US); Sam Butterwick, Chandler, AZ (US); Eric D. Pope, Glendale, AZ (US); Zachery Clark, Sun City, AZ (US)

(21) Appl. No.: 19/097,688

(22) Filed: Apr. 1, 2025

(51) Int. Cl. B01D 19/00; B01D 53/14; B01D 53/18; B01D 53/22; H02K 7/11; H02K 21/14; H02K 49/10

(52) U.S. Cl. CPC B01D 19/0052; B01D 53/1425; B01D 53/1475; B01D 53/18; B01D 53/229; H02K 7/11; H02K 21/14; H02K 49/108; B01D 2257/504

(57) ABSTRACT

A phase separator includes a vessel defining a vessel cavity, a separator assembly enclosed within the vessel cavity, and a motor assembly. The separator assembly includes a drum configured to rotate around an axis. The separator assembly is configured to disperse a liquid along a radially inward surface of the drum during rotation to separate a gas from the liquid. The motor assembly is configured to transmit a magnetic field across a wall of the vessel to rotate the drum.

### TECHNICAL FIELD

The present disclosure relates to systems and techniques for phase separation.

### BACKGROUND

Phase separators may be used for separating fluid streams of life support systems in resource-limited environments, such as outer space. Such resource-limited environments may have low or no gravity, such that gravity may not be relied on to separate liquids from gases, and alternative mechanisms such as surface tension, capillary action, centrifugal forces, or mechanical filtration may be used to separate liquids from gases. For example, dynamic phase separators such as centrifugal or cyclone separators may use rotation to generate centrifugal forces that separate liquids from gases due to differences in density.

### SUMMARY

In general, the disclosure describes a phase separator for separating a gas from a liquid in low vacuum. A phase separator includes a vessel that is maintained under pressure or vacuum and receives a liquid stream that includes a liquid with dissolved or entrapped gas. A separator assembly is housed within the vessel and includes a drum configured to rotate around an axis within the vessel. During operation, the separator assembly disperses the liquid from the liquid stream into a packing distributed along a radially inward surface of the drum. The high surface area, and optionally vacuum, enables the gas to separate from the liquid. To maintain the vessel at pressure or vacuum, the separator assembly is enclosed and sealed within the vessel, such that the vessel maintains a tight seal with only static breaks in a containment of the vessel. To rotate the drum in this sealed manner, the phase separator includes a motor assembly that transmits a magnetic field across a wall of the vessel to rotate the drum. For example, the motor assembly may include an external stator and internal rotor attached to the drum, or may include a magnetic clutch that magnetically connects a motor to the drum. By wholly containing the separation assembly within the vessel, the phase separator may have improved sealing and service life compared to a separation assembly with dynamic seals around a rotating shaft.

In some examples, the disclosure describes a phase separator that includes a vessel defining a vessel cavity, a separator assembly enclosed within the vessel cavity, and a motor assembly. The separator assembly includes a drum configured to rotate around an axis. The separator assembly is configured to disperse a liquid along a radially inward surface of the drum and separate a gas from the liquid. The motor assembly is configured to transmit a magnetic field across a wall of the vessel to rotate the drum.

In some examples, the disclosure describes a contaminant removal system that includes a scrubber, a stripper, a liquid sorbent circuit, and a vacuum system. The scrubber is configured to absorb one or more contaminants from an air stream using a liquid sorbent mixture. The stripper is configured to desorb the one or more contaminants from a liquid sorbent in the liquid sorbent mixture into a contaminant stream. The stripper includes a phase separator that includes a vessel defining a vessel cavity, a separator assembly enclosed within the vessel cavity, and a motor assembly. The vessel is configured to receive the liquid sorbent mixture. The separator assembly includes a drum configured to rotate around an axis. The separator assembly is configured to disperse the liquid sorbent mixture along a radially inward surface of the drum during rotation to desorb the one or more contaminants from the liquid sorbent mixture. The motor assembly is configured to transmit a magnetic field across a wall of the vessel to rotate the drum. The liquid sorbent circuit is configured to circulate the liquid sorbent mixture between the scrubber and the stripper. The vacuum system configured to generate a vacuum on the stripper.

In some examples, the disclosure describes a method for separating a gas from a liquid includes receiving, by a vessel, the liquid, and dispersing, by a separator assembly enclosed within a vessel cavity of the vessel, the liquid along a radially inward surface of a drum of the separator assembly. The drum is configured to rotate around an axis. The method further includes transmitting, by a motor assembly, a magnetic field across a wall of the vessel to rotate a drum of the separator assembly around an axis to separate the gas from the liquid.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1 is a conceptual block diagram illustrating a liquid processing system that includes an example phase separator.

FIG. 2A is a cross-sectional side view diagram illustrating an example phase separator.

FIG. 2B is a cross-sectional side view diagram illustrating an example phase separator.

FIG. 3 is a flowchart of an example technique for separating a liquid and a gas.

FIG. 4A is a schematic diagram illustrating an example contaminant removal system that includes a phase separator for desorbing contaminants from a liquid sorbent.

FIG. 4B is an example flowchart of a method for removing contaminants using a phase separator to desorb contaminants from a liquid sorbent.

### DETAILED DESCRIPTION

In general, the disclosure describes phase separators and methods for separating a liquid from a gas that use a magnetic force to drive rotation of a separation assembly within a sealed vessel. Phase separators described herein may be used in a variety of liquid processing systems, such as liquid processing systems in low- or no-gravity environments. For example, phase separators may be used in contaminant removal systems in resource limited environments to desorb contaminants from a liquid sorbent.

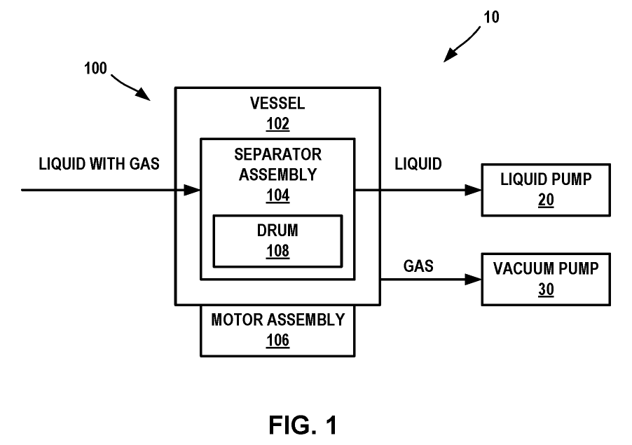

FIG. 1 is a conceptual block diagram illustrating a liquid processing system 10 that includes an example phase separator 100. Phase separator 100 is configured to separate a gas from a liquid in a liquid stream. A liquid stream may include any fluid stream that is primarily liquid with gases dissolved or entrapped in the liquid. As one example, liquid sorbent mixtures of contaminant removal systems may include contaminants, such as carbon dioxide and water, absorbed by a liquid sorbent. Without recovery, these contaminants may be discharged overboard. As another example, various fluid streams of life support systems may include gases dissolved or entrapped in liquids. Without removal, these gases may cause damage to equipment, such as cavitation to a liquid pump 20 downstream of phase separator 100 or may be discharged without recovery. Such fluid streams may include, but are not limited to, liquid sorbent mixtures, such as ionic liquids with absorbed contaminants; water and oxygen mixtures, such as oxygenated water or electrolysis products; carbonated water or ionic liquid recovered from liquid sorbent mixtures; wastewater streams with dissolved gases; industrial feedwater streams with ammonia; drinking water streams with volatile organic compounds (VOCs) such as hydrogen sulfide, and the like.

Phase separator 100 includes a vessel 102, a separator assembly 104, and a motor assembly 106. Vessel 102 houses separator assembly 104 within a vessel cavity. Vessel 102 may be kept under vacuum via vacuum pump 30, or under pressure by a pressurizing system (not shown). For example, desorption of gases from a low vapor pressure liquid sorbent may be aided by maintaining a vacuum in vessel 102. Separator assembly 104 includes a drum 108 configured to rotate around an axis. Separator assembly 104 is configured to disperse a liquid along a radially inward surface of drum 108. Motor assembly 106 is configured to rotate drum 108, generating a centrifugal force that separates the gas from the liquid due to differences in density. The separated liquid may be pumped to another system, such as via liquid pump 20, and the separated gas may be pumped to another system, such as via vacuum pump 30. Alternatively, separator assembly 106 may itself function as a pump to impart significant pumping force to the liquid.

In a conventional phase separator, where a motor may be located outside a vessel, a dynamic seal is required to transfer torque generated by a motor to the drum while maintaining the vessel at vacuum pressure. These dynamic seals may adequately seal the vessel at low pressure differentials, such as around ambient pressures, but may not be capable of forming a sufficiently tight seal under pressure or vacuum. Further, such dynamic seals may be prone to leakage as the dynamic seals age. Alternatively, the motor may be sealed in the vessel with the drum to eliminate the dynamic seal. However, enclosing the motor may subject the motor to increased wear and reduced life expectancy from exposure to liquid sorbent or gas contaminants and poor heat transfer in the vacuum environment.

As described herein, phase separator 100 may separate the gas from the liquid under vacuum or pressure while maintaining adequate containment of vessel 102. Rather than extending one or more torque transfer components of separator assembly 104 across vessel 102, separator assembly 104 is wholly enclosed within the vessel cavity of vessel 102. Motor assembly 106 is configured to transmit a magnetic field across a wall of vessel 102 to rotate drum 108. For example, motor assembly 106 may transmit a changing magnetic field across vessel 102 to induce rotation of drum 108 or may transmit a coupling magnetic field across vessel 102 to mirror rotation of drum 108.

Regardless of how the magnetic field is generated, portions of motor assembly 106 that generate the magnetic field may remain outside vessel 102, enabling maintenance of these components and providing a less corrosive environment for these components to operate within. Breaks in the containment of vessel 102 may be limited to liquid inlet and outlet ports, a gas port, and a sealing interface between a lid and a chamber of vessel 102. In this way, vessel 102 may remain tightly sealed during operation under vacuum or pressure, enabling efficient separation and longer service life of phase separator 100 compared to phase separators that either include dynamic seals for sealing a shaft across a vessel or contain a motor within a vessel.

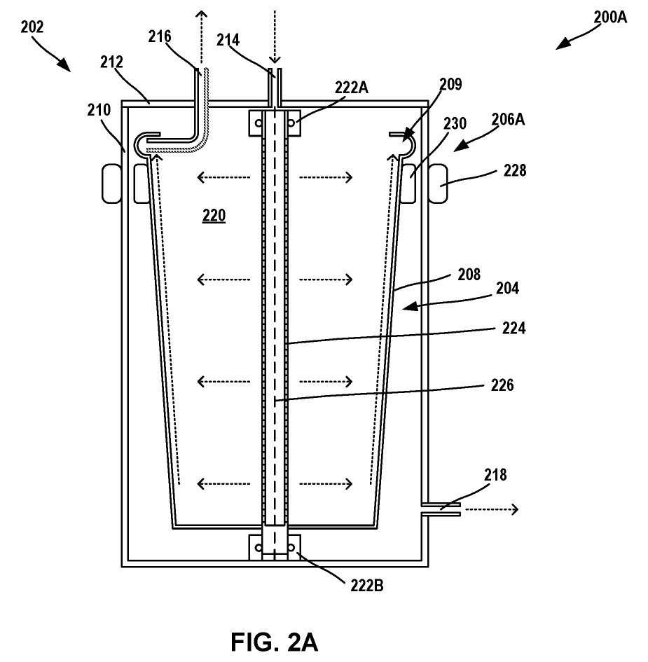

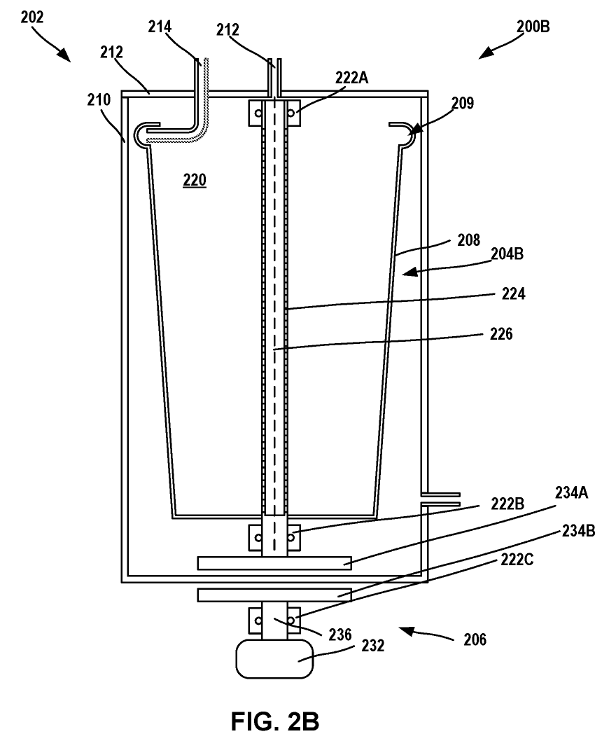

FIG. 2A is a cross-sectional side view diagram illustrating an example phase separator 200A, which is one example of phase separator 100 of FIG. 1. Phase separator 200A includes a vessel 202. Vessel 202 includes a vessel chamber 210 and a vessel lid 212 that define a vessel cavity 210 for separating a gas from the liquid. Vessel 202 is configured to form a containment boundary for maintaining a vacuum or pressure within vessel cavity 220. Once positioned, vessel chamber 210 and vessel lid 212 may be configured to substantially prevent the gases from migrating into or out of vessel cavity 220. Vessel lid 212 may be configured to contact a wall of vessel chamber 210 at a sealing interface to form a contact seal. For example, a surface of each of vessel lid 212 and vessel chamber 210 at the sealing interface may have a relatively low roughness. The contact seal may not include a gasket or other potentially degradable material.

Vessel 202 includes various ports that are coupled to vessel chamber 210 or vessel lid 212 and enable connection to various other systems or components. These ports may be welded to vessel chamber 210 and/or vessel lid 212, such that the ports may be substantially sealed during operation of phase separator 200A. While illustrated in the example of FIG. 2A as discharging to an atmosphere, in some examples, vessel 202 includes liquid and/or gas storage systems, such as tanks, configured to receive the discharged separated liquid and gas.

Vessel 202 includes an inlet port 214 configured to receive an untreated liquid into vessel 202, and optionally aid in dispersing the untreated liquid into vessel 202. In some examples, inlet port 214 may include a spray nozzle or other structure configured to generate liquid droplets from the liquid stream. For example, a spray nozzle may generate fine droplets that improve coalescence of gas bubbles, distribute the liquid more evenly on drum 208, produce a thinner liquid film on drum 208, or control residence time of the liquid on drum 208.

Vessel 202 includes an outlet port 216 configured to discharge treated liquid from vessel 202, and optionally aid in collecting and/or measuring the treated liquid from vessel 202. Outlet port 216 is fluidically coupled to the radially inward surface of drum 208. In the example of FIG. 2A, outlet port 216 extends into vessel cavity 220 such that an inner portion of outlet port 216 is positioned near an accumulation region 209 of drum 208 to feed separated liquid that has accumulated in accumulation region 209 into outlet port 216. In some examples, outlet port 216 includes a pitot tube or other measurement device configured to measure an amount of liquid collected from separation assembly 204. Such measurement may aid in controlling various operational parameters of phase separator 200A, such as a rotational speed of drum 208, a spray distribution of the liquid from inlet port 214, or other parameter that may influence an amount of liquid that is collected.

Vessel 202 includes a port 218 configured to fluidically couple to a vacuum or pressure source, and correspondingly maintain a vacuum or pressure within vessel cavity 220. For example, port 218 may be coupled to a vacuum pump that generates the vacuum in vessel cavity 220, such as a vacuum of less than about 6.5 kPa.

Phase separator 200A includes a separator assembly 204 housed within vessel cavity 222. Separator assembly 204 is configured to receive the liquid stream via inlet port 214 and separate a gas from the liquid stream. Separator assembly 204 includes a drum 208. Drum 208 is configured to rotate around an axis 226, such as supported through an upper bearing 222A and a lower bearing 222B. Drum 208 includes a radially inward surface. In the example of FIG. 2A, drum 208 has a tapered shape, such that a diameter of drum 208 varies along axis 226.

Separator assembly 204 is configured to disperse a liquid along the radially inward surface of drum 208 while drum 208 is rotating to separate the gas from the liquid. This separation is driven using centrifugal force and enhanced by a large surface area and residence time of drum 208. Without being limited to any particular theory, separation of a gas dispersed in a liquid relies on the difference in density between the gas phase and the liquid phase and the application of centrifugal force. As drum 208 rotates at high speeds, drum 208 generates a strong centrifugal force that acts radially outward from axis 226, and a magnitude of the centrifugal force increases with the distance from axis 226. The centrifugal force affects the liquid and the dispersed gas differently due to a difference in density. The denser liquid experiences a stronger outward force and moves towards the outer walls of drum 208. In contrast, the less dense gas experiences a weaker force, causing it to migrate towards the center of rotation. As a result, the liquid phase forms a continuous layer along the outer walls of drum 208 due to its higher density, and the gas phase accumulates closer to axis 226, forming bubbles or a continuous gas core depending on the volume and flow rates.

In some examples, the inward radial surface of drum 208 includes packing to provide that gas in the liquid with time to migrate from the liquid to the surface and escape to cavity 220. The packing may be configured to increase a surface area and/or residence time of the liquid on drum 208. For example, the packing may have a structure that provides surfaces for the liquid to flow over without becoming trapped, and may adjust a flow rate of the liquid along the inward radial surface of drum 208. As a result, a greater volume of the liquid may be flowed over drum 208 with a target residence time.

The tapered shape of drum 208 may aid in directing the separated phases. As drum 208 rotates, the liquid travels along the radially inward surface of drum 208. Drum 208 includes an accumulation region 209 configured to collect the liquid phase flowing along the radially inward surface. Once in accumulation region 209, the treated liquid may be suctioned into outlet port 216 to be discharged from vessel 202. The widening or narrowing of drum 208 aids in controlling velocity gradients and residence times to enhance separation efficiency. Drum 208 may also aid in gradually reducing a radial distance of the liquid layer, allowing gas to coalesce and move axially towards accumulation region 209. The separated gas may be collected and discharged through port 218. The treated liquid exits through outlet port 216.

A variety of structural parameters may be selected to increase an efficiency of separation including, but not limited to, a surface area of drum 208, an effective surface area of packing of drum 208, surface properties of drum 208, and the like. A variety of operational parameters may be controlled to increase an efficiency of separation including, but not limited to, vacuum, rotational speed, liquid viscosity, gas bubble size, and the like. For example, higher speeds may improve separation by increasing the centrifugal force but may cause smaller gas bubbles to remain entrained in the liquid if the residence time is too short for complete migration.

In the example of FIG. 2A, separator assembly 206A includes an inlet cylinder 224 aligned with axis 226. Inlet cylinder 224 is configured to aid in dispersing the liquid received from inlet port 214 into drum 208. For example, inlet cylinder 224 may include pores or other holes that enable the liquid to be dispersed through the packing and onto the radially inward surface of drum 208. The pores may be arranged to achieve a desired distribution or residence time of the liquid on drum 208.

To maintain the containment boundary of vessel cavity 220, such as while under vacuum, connections into and from vessel 202 may be static. For example, the various ports connected to vessel 202 and the sealing interface between vessel lid 212 and vessel chamber 210 may all be static. As a result, separator assembly 204 may be enclosed within vessel cavity 222. For example, separator assembly 204 may not include any physical dynamic connection, such as a shaft, that extends through vessel 202. Instead, ports 214, 216, and 218, and the seal between vessel chamber 210 and vessel lid 212, may represent the only breaks in vessel 202. As such, various parameters of ports 214, 216, 218 and vessel chamber 210 and vessel lid 212 may be selected or configured to maintain a desired vacuum or pressure within vessel cavity 220, such as a smoothness of contact surfaces of vessel chamber 210 and vessel lid 212, and an integrity of welds of ports 214, 216, 218 with vessel chamber 210 or vessel lid 212.

Phase separator 200A include a motor assembly 206A. To rotate drum 208 of enclosed separator assembly 204, motor assembly 206A is configured to transmit a magnetic field across a wall of vessel 202. In the example of FIG. 2A, motor assembly 206A includes a stator 228 and a plurality of magnets 230 and is configured to operate as a synchronous motor. Stator 228 is positioned around at least a portion of a wall of vessel 202, such as a wall of vessel chamber 210, and includes electromagnets arranged around an inner surface of stator 228 toward vessel 202. The plurality of magnets 230 are coupled to drum 208 and arranged with alternating north and south poles around the circumference of drum 208. Stator 228 is configured to generate a rotating magnetic field that interacts with the plurality of magnets 230. The plurality of magnets on drum 208 are attracted to or repelled by the magnetic field produced by stator 228. Since the magnetic field is constantly rotating, drum 208 experiences a continuous torque that causes it to follow the rotating field, thereby causing the rotation of drum 208.

Motor assembly 206A includes a motor controller (not shown). The motor controller may be configured to regulate the current at the stator windings of stator 228 to control a rotational speed of drum 208. In some examples, the motor controller may be configured to receive feedback from drum 208 and use the feedback to maintain rotation of drum 208 within a target range. For example, the motor controller may be configured to receive a feedback signal representative of a torque measurement of drum 208 and control motor assembly 206A to maintain a torque on the drum within a torque range. The torque range may correspond to range to provide a desired rotational speed and does not produce slipping or other maloperation.

FIG. 2B is a cross-sectional side view diagram illustrating an example phase separator 200B, which is another example of phase separator 100 of FIG. 1. In the example of FIG. 2B, motor assembly 206B includes an interior magnetic clutch 234A, an exterior clutch 234B, and a motor 232 magnetically coupled to drum 208 via interior and exterior magnetic clutches 234. External magnetic clutch 234B is physically coupled to motor 232 via a shaft 236 supported by a bearing 222C. Motor 232 is configured to generate torque and transfer the torque to external magnetic clutch 234B to spin external magnetic clutch 234B. Exterior magnetic clutch 234B is configured to generate a magnetic field that interacts with interior magnetic clutch 234A to generate torque on interior magnetic clutch 234A. Interior magnetic clutch 234A is coupled to drum 208 and configured to transfer torque to drum 208 to cause the rotation of drum 208. In the example of FIG. 2B, vessel chamber 210 may be formed from non-magnetic materials, such as stainless steel or graphite.

In some examples, interior and exterior magnetic clutches 234 are permanent magnetic clutches. For example, permanent magnetic clutches may provide constant torque transfer and simplify transfer of torque across vessel. In some examples, at least one of interior or exterior magnetic clutches 234 is an electromagnetic clutch. For example, electromagnetic clutches may be capable of engaging or disengaging the clutch or adjusting torque transfer dynamically, thereby enabling more precise control, such as variable torque setting or rapid disengagement. By maintaining motor 232 external to vessel 202, motor 232 may be replaced or serviced without taking phase separator apart.

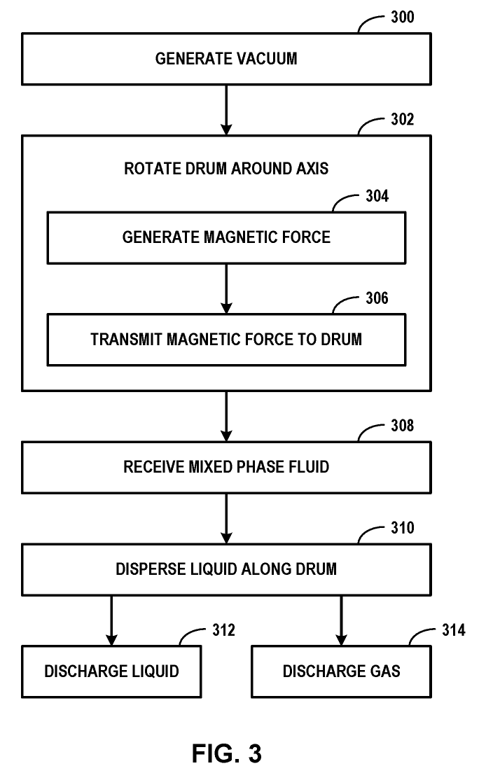

FIG. 3 is a flowchart of an example method for separating a liquid and a gas. The method of FIG. 3 will be described with respect to FIGS. 2A and 2B; however, other phase separators may be operated according to the method described in FIG. 3. In some examples, the method of FIG. 3 includes generating a vacuum (300). For example, a vacuum pump or other source fluidically coupled to port 218 of vessel 202 may generate a vacuum within vessel cavity 220. This vacuum may be substantially high such that a gas can be contained within vessel cavity 220, but substantially low that the gas may otherwise leak from a dynamic seal, such as a dynamic seal.

The method of FIG. 3 includes rotating drum 208 around axis 226 (302). To rotate drum 208, the method of FIG. 3 includes generating, by motor assembly 206, a magnetic field (304) and transmitting, by motor assembly 206, the magnetic field across a wall of vessel 202 to drum 208 (306). For example, a motor controller may control a stator of motor assembly 206 to generate either a rotating or coupling magnetic field. In the example of FIG. 2A, in which motor assembly 206A includes a plurality of magnets 230 coupled to drum 208 and stator 228 positioned around at least a portion of vessel 202, the method includes generating a rotating magnetic field that interacts with plurality of magnets 230 to cause the rotation of drum 208. In the example of FIG. 2B, in which motor assembly 206B includes a motor 232, an interior magnetic clutch 234A coupled to drum 208, an external magnetic clutch 234B coupled to motor 234, the method includes generating a torque and transmitting, by interior and exterior magnetic clutches 234, the torque via a coupling magnetic field to cause the rotation of drum 208.

The method of FIG. 3 includes receiving a liquid stream into vessel 202 (308). The liquid stream may be predominantly liquid, but may include gas dissolved or entrained in the liquid. In some examples, receiving the liquid stream may include generating droplets from the liquid, such as by using a spray nozzle.

The method of FIG. 3 includes dispersing, by separator assembly 204, the liquid along a radially inward surface of drum 208 (310). The centrifugal force generated by the rotation of drum 208 causes the gas to separate from the liquid. In some examples, motor assembly 206 may control separation of the gas from the liquid by controlling a rotational speed of drum 208. Other parameters that may be controlled to control separation may include, but are not limited to, a size and velocity of the spray nozzle, a vacuum or pressure within vessel cavity 220, or any other parameter that may control a residence time of liquid on drum 208 or rate of formation and migration of gas bubbles from the liquid on drum 208.

The method of FIG. 3 includes discharging, by outlet port 216, the separated liquid from vessel 202 (312) and discharging, by port 218, the separated gas from vessel 202 (314).

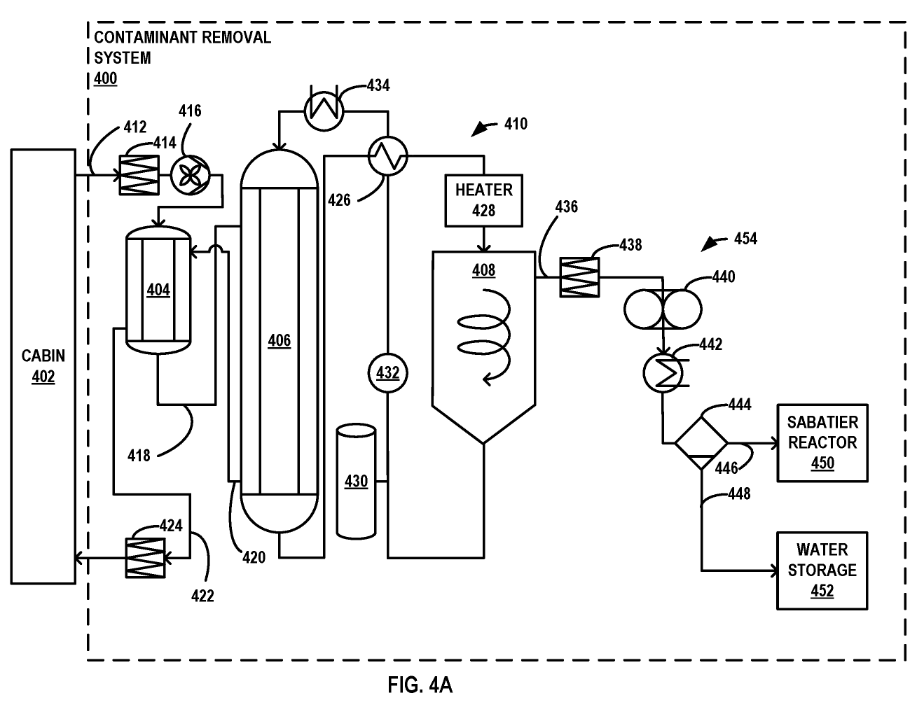

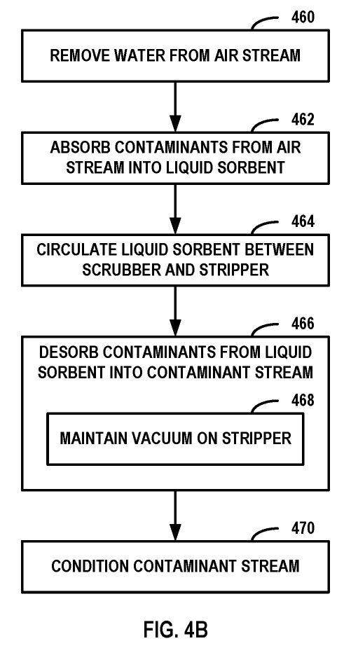

Phase separators described herein may be used as stripper separators to desorb gases, such as contaminants, from a liquid, such as a liquid sorbent mixture that includes a liquid sorbent. For example, liquid sorbents may have relatively low vapor pressures, such that phase separators capable of operating at low pressure may enable efficient separation of gases absorbed by the liquid sorbents. FIG. 4A is a schematic diagram illustrating an example contaminant removal system that includes a phase separator for desorbing contaminants from a liquid sorbent. Contaminant removal system 400 may be utilized as part of an environmental control system (ECS), such as in watercraft, aircraft, spacecraft, and the like, to remove contaminants from a cabin 402. Contaminant removal system 400 is configured to remove at least a portion of the contaminants in a cabin air stream 412 using one or more liquid sorbents. A liquid sorbent may include any liquid configured to absorb and desorb a gaseous species. Liquid sorbents may be water soluble, hygroscopic (i.e., capable of absorbing moisture from the air), capable of absorbing or desorbing contaminants in response to a change in solubility driven by a change in temperature, and/or capable of releasing water by evaporation, such as by elevating the temperature or reducing the water partial pressure in the gas phase surrounding the liquid sorbent. In some examples, the liquid sorbent may be an ionic liquid sorbent. A variety of ionic liquid sorbents may be used including, but not limited to, imidazolium salts, such as 1-ethyl-3-methylimidazolium (EMIM) acetate (Ac).

In contaminant removal system 400, the liquid sorbent is dissolved in water to form a liquid sorbent mixture. A concentration of liquid sorbent in the liquid sorbent mixture may be sufficiently high to remove a particular or set of contaminants and sufficiently low that the liquid sorbent remains in solution through operating ranges (e.g., temperature range, pH range) and/or maintains a low viscosity for maintaining high mass transfer. In some examples, the liquid sorbent mixture may further include a dissolved promoter. The promoter may be configured to increase a rate of removal of a contaminant, such as water or carbon dioxide, from an air stream. For example, the promoter may be configured to reduce a viscosity of the liquid sorbent, change a pH of the liquid sorbent, increase a thermal stability of the liquid sorbent, increase a capacity of the liquid sorbent for the contaminant, or increase an absorption rate of the contaminant into the liquid sorbent. Absorption of the contaminants by the liquid sorbent may be determined by a concentration of the contaminants in the corresponding air stream. Liquid sorbents may be used with separators that contact an air stream with or draw an air stream from the liquid sorbent, such as across one or more hydrophobic porous membranes (e.g., membrane contactors), on a surface of packing media (e.g., packed bed or rotary contactors), or on a surface during rotation (e.g., centrifugal phase separators).

Contaminant removal system 400 includes a cabin air circuit (not labeled) configured to circulate cabin air between a cabin 402 and scrubber 406 via a membrane dehumidifier 404. In the example of FIG. 4A, cabin air stream 412 includes a filter 414 configured to remove particulates from cabin air stream 412 prior to entry into scrubber 406 and a blower 416 configured to draw cabin air into scrubber 406, while clean air stream 422 includes a filter 424 configured to remove any leaked liquid sorbent mixture and/or further filter clean air from clean air stream 422 prior to entry into cabin 402.

In the example of FIG. 4A, contaminant removal system 400 includes membrane dehumidifier 404 to capture humidity from cabin air stream 412 to recover humidity into clean air stream 422 that may otherwise be absorbed by the liquid sorbent at scrubber 406. For example, membrane dehumidifier 404 may be positioned between cabin 402 and scrubber 406, such that cabin air received by scrubber 406 may include a lower humidity than cabin air received by contaminant removal system 400 from cabin 402. On one side, membrane dehumidifier 404 may be configured to receive cabin air stream 412 as a feed gas stream and discharge cabin air in a dehumidified air stream 418 to scrubber 406 having a lower humidity. On an opposite side, membrane dehumidifier 404 may be configured to receive a dehumidified clean air stream 420 from scrubber 406 and discharge clean air to clean air stream 422 having a higher humidity. By capturing humidity from cabin air prior to entry of the cabin air from cabin air stream 412 into scrubber 406, a greater amount of humidity may be preserved and/or a reduced amount of water may be removed by stripper 408 through evaporative cooling.

Scrubber 406 may include one or more membrane separators configured to flow air on a first side and flow liquid sorbent mixture on a second, opposite side. For example, a membrane separator may include a plurality of parallel membrane contactors. A membrane contactor may include a cylindrical module filled with parallel or woven hollow porous fibers forming a hydrophobic porous membrane. Fiber materials may include, but are not limited to, hydrophobic materials such as polypropylene, polyvinylidene fluoride, polysulfone, polyimide, polytetrafluoroethylene (PTFE), and the like. While described in FIG. 4A as flowing through a “tube” side, liquid sorbent mixture flow can be either on the “tube” side or the “shell” side, while gas is flowed on the opposite side.

Scrubber 406 is configured to absorb one or more contaminants from cabin air stream 412 into the liquid sorbent and discharge a clean air stream 422 to cabin 402. Clean air stream 422 has a lower concentration of contaminants than cabin air stream 412. For example, clean air stream 422 may have a concentration of carbon dioxide that is about 25% to about 99% less than a concentration of carbon dioxide in cabin air stream 412. Scrubber 406 includes one or more separation membranes, each configured to flow (e.g., provide or direct flow of) cabin air from cabin air stream 412 on a gas phase side (e.g., a tube side) of the respective membrane and flow the liquid sorbent mixture on a liquid phase side (e.g., a shell side) of the membrane.

On a gas phase side, scrubber 406 is configured to receive cabin air from cabin air stream 412 that includes contaminants from cabin 402. Contaminants may pass through the membrane due to a concentration gradient between the cabin air and the liquid sorbent mixture and become absorbed by the liquid sorbent, while the liquid sorbent mixture may not substantially flow through the membrane. As a result, clean air from clean air stream 422 discharged from scrubber 406 may have a lower concentration of contaminants than cabin air from cabin air stream 120 received by scrubber 406. Scrubber 406 is configured to discharge clean air stream 422 to cabin 402 via membrane dehumidifier 404. On a liquid phase side, scrubber 406 is configured to receive unloaded liquid sorbent mixture, such as from a liquid sorbent storage 430. The unloaded liquid sorbent mixture may flow through scrubber 406 and absorb carbon dioxide and other gaseous contaminants from cabin air through the membrane(s) of scrubber 406. As a result, the loaded liquid sorbent mixture discharged from scrubber 406 may have a higher concentration of contaminants than the unloaded liquid sorbent mixture received by scrubber 406. Scrubber 406 may discharge the loaded liquid sorbent mixture containing the contaminants to stripper 408.

Stripper 408 is configured to desorb the contaminants, including carbon dioxide, from the liquid sorbent into contaminant stream 436. Stripper 408 includes one or more phase separators, such as phase separator 100 of FIG. 1A, phase separator 200A of FIG. 2A, or phase separator 200B of FIG. 2B. Each phase separator is configured to receive the liquid sorbent mixture, generate a centrifugal force that aids in separating the one or more contaminants from the liquid sorbent, and discharges the one or more contaminants to contaminant stream 436 and the unloaded liquid sorbent mixture back to scrubber 406. Each phase separator includes a vessel defining a vessel cavity and configured to receive the liquid sorbent mixture that includes the liquid sorbent. A separator assembly enclosed within the vessel cavity includes a drum configured to rotate around an axis. The separator assembly is configured to disperse the liquid sorbent mixture along a radially inward surface of the drum during rotation. The liquid sorbent mixture has a very low vapor pressure relative to the dissolved gas, such that the separator assembly may be maintained at a low vacuum, such as less than about 6.5 kPa. The centrifugal force assists in driving separation of the one or more contaminants from the liquid sorbent to desorb the one or more contaminants from the liquid sorbent. A motor assembly is configured to transmit a magnetic field across a wall of the vessel to rotate the drum. As a result, unloaded liquid sorbent mixture discharged from stripper 408 may have a lower concentration of contaminants than the loaded liquid sorbent mixture received by stripper 408. Contaminant stream 436 may be continuously removed from stripper 408 to assist migration of the contaminants from the loaded liquid sorbent mixture into contaminant stream 436.

Contaminant removal system 400 includes liquid sorbent circuit 410 configured to circulate liquid sorbent mixture between scrubber 406 and stripper 408. For example, a pump 432 may pump unloaded liquid sorbent mixture from stripper 408 into scrubber 406. Unloaded liquid sorbent mixture may include unused liquid sorbent free of contaminants or regenerated liquid sorbent having a lower concentration of contaminants than the loaded liquid sorbent mixture. Liquid sorbent storage 430 may store liquid sorbent, such as in a relatively cool state.

Liquid sorbent circuit 410 may include one or more components for controlling a temperature of the liquid sorbent mixture. In some examples, the unloaded liquid sorbent mixture may be cooled by a regenerative heat exchanger 426 and/or a heat exchanger 434 prior to entry into scrubber 406. Heat exchanger 426 is configured to exchange heat between a relatively hot unloaded liquid sorbent mixture from stripper 408 and a relatively cool loaded liquid sorbent mixture from scrubber 406. Heat exchanger 434 is configured to receive the unloaded liquid sorbent mixture from stripper 408, cool the unloaded liquid sorbent mixture, and discharge the cooled, unloaded liquid sorbent mixture to scrubber 406. Liquid sorbent circuit 410 may include one or more heaters 428 upstream of stripper 408. Heaters 428 may be configured to heat the liquid sorbent prior to entry into stripper 408 to increase desorption of contaminants from the liquid sorbent.

In the example of FIG. 4A, contaminant removal system 400 may include one or more systems or components, such as a conditioning assembly 454, configured to further process contaminant stream 436, such that carbon dioxide may be isolated and pressurized for reaction in Sabatier reactor 450. Contaminant removal system 400 includes Sabatier reactor 450 configured to generate hydrocarbons using carbon dioxide removed by scrubber 406. Sabatier reactor 450 may require a water concentration of less than 10% to react hydrogen with carbon dioxide. However, in a life support application, a large amount of water may be present in cabin air stream 412.

Conditioning assembly 454 includes a vacuum pump 440, a condenser 442, and a water separator 444 configured to pressurize contaminant stream 436 and remove water from the compressed contaminant stream. For example, for carbon dioxide removed from stripper 408 to be reacted efficiently by Sabatier reactor 450, vacuum pump 440, condenser 442, and water separator 444 may pressurize contaminant stream 436 to a moderate pressure and remove nearly all water from contaminant stream 436. In some examples, contaminant removal system 400 includes a filter 438 configured to remove entrained liquid sorbent mixture from contaminant stream 436.

Vacuum pump 440 is configured to maintain a vacuum on stripper 408 and pressurize contaminant stream 436. For example, vacuum pump 440 may be configured to compress contaminant stream 436 from less than or equal to about 6.5 kilopascals (kPa) up to a pressure between about 50 kPa and about 100 kPa. In the example of FIG. 4A, vacuum pump 440 is configured to pressurize the carbon dioxide to a reaction pressure. In some examples, the reaction pressure is less than about 100 kPa. A variety of vacuum pumps may be used for vacuum pump 440 including, but not limited to, centrifugal compressors, positive displacement compressors, and the like. Condenser 442 is configured to cool contaminant stream 436 and condense water from contaminant stream 436. For example, condenser 442 may be coupled to a cooling medium system or other cooling system that circulates a cooling medium to cool contaminant stream 436. Water separator 444 is positioned upstream of Sabatier reactor 450 and is configured to separate desorbed water from the carbon dioxide. Water separator 450 may be configured to remove water from contaminant stream 436, discharge a purified contaminant stream 446 to Sabatier reactor 450, and discharge water condensate stream 448 to water storage 452.

Sabatier reactor 450 is configured to generate methane from the carbon dioxide and, to a lesser degree, carbon monoxide. Sabatier reactor 450 includes a catalyst configured to increase a reaction rate of the Sabatier reaction. In some examples, a structure of the catalyst may be configured to further increase thermal and/or mass transfer of reactants and products. For example, Sabatier reactor 450 may include a catalyst in the form of any of a mesh, a packed bed, a microchannel grid, or other structure or combination of structures having a high surface area, high thermal conductivity, and/or high reactant throughput. Catalysts that may be used include, but are not limited to, nickel, ruthenium, rhodium, and the like, alone or on a support, such as aluminum oxide. In some examples, Sabatier reactor 450 is configured to operate at a relatively high carbon dioxide conversion (e.g., >70%) and methane selectivity (e.g., >80%) at relatively low temperatures and pressures. For example, the catalyst may be configured to achieve such high carbon dioxide conversion and methane selectivity at temperatures less than about 450 ℃ and/or pressures less than about 100 kPa.

Contaminant removal system 400 may include a control system (not shown) communicatively coupled to and configured to receive measurement signals from one or more sensor sets, and other process control components (not shown) of contaminant removal system 400. The control system is configured to control a concentration of one or more contaminants within the environment of cabin 402. For example, the control system may be configured to receive a concentration measurement for a contaminant, such as carbon dioxide, such as from a cabin air sensor set or a carbon dioxide concentration sensor in cabin 402. The control system may be configured to determine whether the concentration measurement of the contaminant exceeds a concentration setpoint. For example, the concentration setpoint may be a target concentration of the contaminant for maintaining cabin 402 below a threshold contaminant concentration. The control system may be configured to send, in response to the concentration measurement of the contaminant exceeding the concentration setpoint, a control signal to decrease a concentration of the contaminant in an air stream returned to cabin 402. For example, the control system may send a control signal to control a flow rate of the liquid sorbent mixture; a temperature of the liquid sorbent mixture at scrubber 406 or stripper 408; a flow rate of cabin air stream 412 from cabin 402; a vacuum at stripper 408; a rotational speed or torque at stripper 408; or any other variable that may control a rate of removal of the contaminant from the cabin air stream from cabin 402 and/or a rate of desorption of the contaminant from the liquid sorbent.

FIG. 4B is an example flowchart of a method for removing contaminants using a phase separator to desorb contaminants from a liquid sorbent. FIG. 4B will be described with respect to FIG. 4A; however, other systems may be used to perform the method of FIG. 4B, including for liquid streams other than contaminant streams.

The method of FIG. 4B includes removing water from a cabin air stream (460). For example, dehumidifier 404 may be maintained at particular conditions, such as flow rate of the cabin air stream or temperature of cooling fluid in dehumidifier 104, to facilitate removal of water to another fluid stream, such as by controlling a blower or a chiller. These particular conditions may be based on a particular measured or anticipated humidity of the cabin air stream.

The method of FIG. 4B includes absorbing one or more contaminants from a cabin air stream into a liquid sorbent (462). For example, liquid sorbent circuit 410 may maintain scrubber 406 at particular conditions, such as temperature and flow rate of liquid sorbent mixture, to facilitate transfer of the one or more contaminants into the liquid sorbent mixture, such as by controlling a pump to circulate the liquid sorbent mixture between scrubber 406 and stripper 408, controlling heat exchanger 434 to cool the liquid sorbent mixture prior to entry into scrubber 406, and/or controlling heat exchanger 426 to recover a portion of heat from liquid sorbent mixture discharged from stripper 408. These particular conditions may be based on a particular measured or anticipated composition of the cabin air stream. The method of FIG. 4B includes circulating the liquid sorbent mixture, including the one or more contaminants, between scrubber 406 and stripper 408 (464).

The method of FIG. 4B includes desorbing the one or more contaminants from the liquid sorbent (466), including by maintaining a vacuum on stripper 108 (468). For example, liquid sorbent circuit 410 and/or conditioning assembly 454 may maintain stripper 408 at particular conditions, such as temperature and flow rate of liquid sorbent mixture and vacuum at stripper 408, to facilitate transfer of the one or more contaminants from the liquid sorbent mixture, such as by controlling conditioning assembly 454 to maintain a vacuum at stripper 408, or controlling heater 428 to heat the liquid sorbent mixture prior to entry into stripper 408. Additionally, stripper 408 may operate at particular conditions, such as residence time of liquid sorbent mixture, to facilitate transfer of the one or more contaminants from the liquid sorbent mixture, such as by controlling a rotational speed of stripper 408. These particular conditions may be based on a particular measured or anticipated composition of cabin air stream 412.

The method of FIG. 4B includes further conditioning the contaminant stream (470). For example, conditioning assembly 454 may be operated at particular conditions, such as stream flow rate or pressure, to maintain the vacuum on stripper 408, compress contaminant stream 436 received from stripper 408 to a desired pressure, such as about 55 kPa to about 100 kPa for a Sabatier reaction, and remove water from contaminant stream 436.

Example 1: A phase separator includes a vessel defining a vessel cavity; a separator assembly enclosed within the vessel cavity and including a drum configured to rotate around an axis, wherein the separator assembly is configured to disperse a liquid along a radially inward surface of the drum during rotation to separate a gas from the liquid; and a motor assembly configured to transmit a magnetic field across a wall of the vessel to rotate the drum.

Example 2: The phase separator of example 1, wherein the vessel includes a port configured to generate a vacuum within the vessel cavity.

Example 3: The phase separator of any of examples 1 and 2, wherein the vessel includes: an inlet port configured to receive the liquid into the vessel; and an outlet port fluidically coupled to the radially inward surface of the drum and configured to discharge the separated liquid from the vessel.

Example 4: The phase separator of example 3, wherein the separator assembly further comprises an inlet cylinder aligned with the axis and configured to disperse the liquid received from the inlet port into the drum.

Example 5: The phase separator of any of examples 3 and 4, wherein the inlet port includes a spray nozzle configured to generate droplets from the liquid.

Example 6: The phase separator of any of examples 1 through 5, wherein the motor assembly comprises: a plurality of magnets coupled to the drum; and a stator positioned around at least a portion of the vessel to generate the magnetic field that interacts with the plurality of magnets to cause the rotation of the drum.

Example 7: The phase separator of any of examples 1 through 6, wherein the motor assembly comprises: a motor configured to generate a torque; an interior magnetic clutch coupled to the drum; and an external magnetic clutch coupled to the motor, wherein the interior and exterior magnetic clutches are configured to transmit the torque via the magnetic field to cause the rotation of the drum.

Example 8: The phase separator of example 7, wherein at least one of the interior or exterior magnetic clutches is an electromagnetic clutch.

Example 9: The phase separator of any of examples 1 through 8, wherein the vessel includes a vessel chamber and a vessel lid configured to form a contact seal.

Example 10: A contaminant removal system includes a scrubber configured to absorb one or more contaminants from an air stream using a liquid sorbent in a liquid sorbent mixture; a stripper configured to desorb the one or more contaminants from the liquid sorbent into a contaminant stream, wherein the stripper comprises a phase separator includes a vessel defining a vessel cavity and configured to receive the liquid sorbent mixture; a separator assembly enclosed within the vessel cavity and including a drum configured to rotate around an axis, wherein the separator assembly is configured to disperse the liquid sorbent mixture along a radially inward surface of the drum during rotation to desorb the one or more contaminants from the liquid sorbent; and a motor assembly configured to transmit a magnetic field across a wall of the vessel to rotate the drum; and a liquid sorbent circuit configured to circulate the liquid sorbent mixture between the scrubber and the stripper; and a conditioning assembly configured to maintain a vacuum on the stripper.

Example 11: The contaminant removal system of example 10, wherein the one or more contaminants include carbon dioxide, and wherein the conditioning assembly is configured to maintain a vacuum that is less than about 6.5 kPa.

Example 12: The contaminant removal system of any of examples 10 and 11, wherein the scrubber comprises at least one hollow fiber membrane contactor.

Example 13: A method for separating a gas from a liquid includes transmitting, by a motor assembly, a magnetic field across a wall of a vessel to rotate a drum of a separator assembly enclosed within a vessel cavity of the vessel around an axis; and dispersing, by the separator assembly, the liquid along a radially inward surface of a drum of the separator assembly to separate the gas from the liquid.

Example 14: The method of example 13, further includes receiving, by an inlet port of the vessel, the liquid into the vessel; and discharging, by an outlet port of the vessel fluidically coupled to the radially inward surface of the drum, the liquid from the vessel.

Example 15: The method of any of examples 13 and 14, wherein the motor assembly comprises: a plurality of magnets coupled to the drum; and a stator positioned around at least a portion of the vessel, and wherein the method further comprises generating, by the stator of the motor assembly, the magnetic field that interacts with the plurality of magnets to cause the rotation of the drum.

Example 16: The method of any of examples 13 through 15, wherein the motor assembly comprises: an interior magnetic clutch coupled to the drum; and an external magnetic clutch coupled to a motor, and wherein the method further comprises: generating, by a stator of the motor, a torque; and transmitting, by the interior and exterior magnetic clutches, the torque via the magnetic field to cause the rotation of the drum.

Example 17: The method of any of examples 13 through 16, further comprising maintaining, via a port of the vessel, a vacuum within the vessel cavity.

Example 18: The method of example 17, wherein the liquid comprises a liquid sorbent mixture that includes a liquid sorbent and one or more contaminants absorbed by the liquid sorbent.

Example 19: The method of example 18, wherein the one or more contaminants include carbon dioxide, and wherein the vacuum is maintained at less than about 6.5 kPa.

Example 20: The method of any of examples 18 and 19, further includes absorbing, by a scrubber, the one or more contaminants into the liquid sorbent; and circulating, by a liquid sorbent circuit, the liquid sorbent mixture between the scrubber and the phase separator.

Various examples have been described. These and other examples are within the scope of the following claims.

What is claimed is:

1. A phase separator, comprising:
a vessel defining a vessel cavity;
a separator assembly enclosed within the vessel cavity and including a drum configured to rotate around an axis, wherein the separator assembly is configured to disperse a liquid along a radially inward surface of the drum during rotation to separate a gas from the liquid; and
a motor assembly configured to transmit a magnetic field across a wall of the vessel to rotate the drum.

2. The phase separator of claim 1, wherein the vessel includes a port configured to generate a vacuum within the vessel cavity.

3. The phase separator of claim 1, wherein the vessel includes:
an inlet port configured to receive the liquid into the vessel; and
an outlet port fluidically coupled to the radially inward surface of the drum and configured to discharge the liquid from the vessel.

4. The phase separator of claim 3, wherein the separator assembly further comprises an inlet cylinder aligned with the axis and configured to disperse the liquid received from the inlet port into the drum.

5. The phase separator of claim 3, wherein the inlet port includes a spray nozzle configured to generate droplets from the liquid.

6. The phase separator of claim 1, wherein the motor assembly comprises:
a plurality of magnets coupled to the drum; and
a stator positioned around at least a portion of the vessel to generate the magnetic field that interacts with the plurality of magnets to cause the rotation of the drum.

7. The phase separator of claim 1, wherein the motor assembly comprises:
a motor configured to generate a torque;
an interior magnetic clutch coupled to the drum; and
an external magnetic clutch coupled to the motor,
wherein the interior and exterior magnetic clutches are configured to transmit the torque via the magnetic field to cause the rotation of the drum.

8. The phase separator of claim 7, wherein at least one of the interior or exterior magnetic clutches is an electromagnetic clutch.

9. The phase separator of claim 1, wherein the vessel includes a vessel chamber and a vessel lid configured to form a contact seal.

10. A contaminant removal system, comprising:
a scrubber configured to absorb one or more contaminants from an air stream using a liquid sorbent in a liquid sorbent mixture;
a stripper configured to desorb the one or more contaminants from the liquid sorbent into a contaminant stream, wherein the stripper comprises a phase separator comprising:
a vessel defining a vessel cavity and configured to receive the liquid sorbent mixture;
a separator assembly enclosed within the vessel cavity and including a drum configured to rotate around an axis, wherein the separator assembly is configured to disperse the liquid sorbent mixture along a radially inward surface of the drum during rotation to desorb the one or more contaminants from the liquid sorbent; and
a motor assembly configured to transmit a magnetic field across a wall of the vessel to rotate the drum; and
a liquid sorbent circuit configured to circulate the liquid sorbent mixture between the scrubber and the stripper; and
a conditioning assembly configured to maintain a vacuum on the stripper.

11. The contaminant removal system of claim 10,
wherein the one or more contaminants include carbon dioxide, and
wherein the conditioning assembly is configured to maintain a vacuum that is less than about 6.5 kPa.

12. The contaminant removal system of claim 10, wherein the scrubber comprises at least one hollow fiber membrane contactor.

13. A method for separating a gas from a liquid, the method comprising:
transmitting, by a motor assembly, a magnetic field across a wall of a vessel to rotate a drum of a separator assembly enclosed within a vessel cavity of the vessel around an axis; and
dispersing, by the separator assembly, the liquid along a radially inward surface of a drum of the separator assembly to separate the gas from the liquid.

14. The method of claim 13, further comprising:
receiving, by an inlet port of the vessel, the liquid into the vessel; and
discharging, by an outlet port of the vessel fluidically coupled to the radially inward surface of the drum, the liquid from the vessel.

15. The method of claim 13,
wherein the motor assembly comprises:
a plurality of magnets coupled to the drum; and
a stator positioned around at least a portion of the vessel, and
wherein the method further comprises generating, by the stator of the motor assembly, the magnetic field that interacts with the plurality of magnets to cause the rotation of the drum.

16. The method of claim 13,
wherein the motor assembly comprises:
an interior magnetic clutch coupled to the drum; and
an external magnetic clutch coupled to a motor, and
wherein the method further comprises:
generating, by a stator of the motor, a torque; and
transmitting, by the interior and exterior magnetic clutches, the torque via the magnetic field to cause the rotation of the drum.

17. The method of claim 13, further comprising maintaining, via a port of the vessel, a vacuum within the vessel cavity.

18. The method of claim 17, wherein the liquid comprises a liquid sorbent mixture that includes a liquid sorbent and one or more contaminants absorbed by the liquid sorbent.

19. The method of claim 18,
wherein the one or more contaminants include carbon dioxide, and
wherein the vacuum is maintained at less than about 6.5 kPa.

20. The method of claim 18, further comprising:
absorbing, by a scrubber, the one or more contaminants into the liquid sorbent; and
circulating, by a liquid sorbent circuit, the liquid sorbent mixture between the scrubber and the phase separator.
